(19) United States
(12) Patent Application Publication
(10) Pub. No.: US 2013/0024308 A1
(43) Pub. Date: Jan. 24, 2013

(54) SELF CHECK OUT USING A PORTABLE DEVICE

(71) Applicants: Satyanarayanan Ramaswamy, Cupertino, CA (US); Ajaykumar Idnani, Hoffman Estates, IL (US)

(72) Inventors: Satyanarayanan Ramaswamy, Cupertino, CA (US); Ajaykumar Idnani, Hoffman Estates, IL (US)

(73) Assignee: TATA CONSULTANCY SERVICES LIMITED, Mumbai (IN)

(21) Appl. No.: 13/552,078

(22) Filed: Jul. 18, 2012

Related U.S. Application Data
(60) Provisional application No. 61/508,773, filed on Jul. 18, 2011.

(51) Int. Cl. G06Q 20/18

(52) U.S. Cl. 705/18

(57) ABSTRACT

The present invention relates to a system and method for enabling customer self-checkout using a portable device. The system allows the customer to walk in to a retail store, check out items at the store, pay for the goods and present a proof of payment at the store exit. Thus the invention asserts the possibility of having unmanned stores and benefits the stores and the customers alike. The store benefits by not having to invest in separate space, terminal and employees for check out process, while the customers benefits by not having to wait in queue to check out their goods and pay for the same.

### CROSS REFERENCE TO RELATED APPLICATION[S]

This application claims priority to U.S. Provisional Patent Application to Ramaswamy and Idnani entitled “SELF CHECK OUT USING A PORTABLE DEVICE,” Ser. No. 61/508,773, filed Jul. 18, 2011, the disclosure of which is hereby incorporated entirely herein by reference.

### FIELD OF THE INVENTION

This invention relates generally to a purchase transaction from a retail store and, more particularly, to a system and method for facilitating purchase transaction for customers from the retail store and exiting from the store using a portable device and without involving any single store employee.

### BACKGROUND OF THE INVENTION

Maintaining self-checkout terminals at a retail store involves high investments and requires the consumer to wait in queue to use one of such terminals installed by the store, thus resulting in significant wasted time for the consumer and extra cost for the store owner in the form of extra human resources. If the queue length is too big the consumer may decide not to make a purchase resulting in lost business for the store. Further, the stores are required to station an employee near the self-checkout terminals, just in case the consumers need help with checking out, again resulting in wasted human resources. Additionally, the printing of a transaction record and payment confirmation in the form of receipt that is then used by the store personnel as a proof of purchase is an added burden in the existing purchase transaction systems.

In these systems the store either station an employee near the store exit to verify the purchases made by the consumers, or invest in costly theft detection equipments. Currently, the stores install self-checkout terminals/kiosks at strategic locations in the store, where the consumers bring their goods and scan one item at a time at the terminal. When they have scanned all items the consumers use one of traditional ways to make the payment—cash, credit card, debit card, personal checks, etc. After the payment the consumers receive a printed record of their purchases in the form of a receipt which is then used as a proof of purchase on the way out. However, these systems are often cumbersome for the customers and cause a backup at the checkout as the people scan and pay for the items, resulting in needless delay.

In this regard, need exists for self-checkout using a portable device that provides more efficient way for customers to make purchase transactions without involving even a single store employee in the purchase cycle.

### OBJECTIVES OF THE INVENTION

The principle objective of the invention is to provide a hassle free unmanned, undeterred electronic transaction processing for a consumer in a retail environment.

Another significant object of the invention is to use ultrasonic audio code as a proof of purchase during exit of the retail store premises.

It is another object of the present invention to apply prices, promotions and discounts to the items scanned by the consumer based on the real-time store data.

Yet another object of the invention is to resolve conflicts, if any, at the exit area of the retail store premises.

### SUMMARY OF THE INVENTION

Before the present systems and methods, enablement are described, it is to be understood that this invention in not limited to the particular systems, and methodologies described, as there can be multiple possible embodiments of the present invention and which are not expressly illustrated in the present disclosures. It is also to be understood that the terminology used in the description is for the purpose of describing the particular versions or embodiments only, and is not intended to limit the scope of the present invention.

The present invention proposes a system and method that empowers the customer to perform an unmanned transaction by way of self-checkout using his/her portable device in a retail environment. The invention takes the purchasing experience at any retail store to the next level by eliminating the need of manual checkout and security procedures. The invention utilizes ultrasonic audio code transmitted via a backend server to be verified by the detector or at the exiting terminal(s) of the store.

In one aspect of the invention, the system and method is capable of identifying the store for its exact location and apply the right price, promotion and taxes, whenever the consumer scans a product with the scanner embedded within the portable device. Post scanning, the system is capable of assisting the customer with processing of payments and generation of a confirmation thereof to be transmitted to the back end server for initializing the transmission of ultrasonic audio codes. Finally the system verifies the ultrasonic audio codes received at the detector or at the exit of the store to trigger a predefined event like opening of the security gates and the like.

In another aspect of the invention, the present system and method eliminates the need for a store to have a designated location, terminal and personnel for checkout, thus realizing cost savings for the store. Also, the buying experience of a consumer is significantly improved since he does not have to wait in a queue to scan the goods in his cart and pay for his purchase. Further, the present system and method eliminates the need for a printed payment confirmation that is used as a proof of purchase when exiting the store thus befitting the stores and the consumers alike.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific system and method disclosed in the drawings:

FIG. 1 shows a block diagram representing the components involved in enabling self-checkout for a customer in the retail industry using a portable device, in accordance with a preferred embodiment of the present invention.

FIG. 2 shows a process flow facilitating self-checkout for a customer in a retail store, in accordance with an embodiment of the present invention.

### DETAIL DESCRIPTION OF THE INVENTION

Some embodiments of this invention, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments of the present invention, the preferred methods, and systems are now described. The disclosed embodiments are merely exemplary of the invention, which may be embodied in various forms.

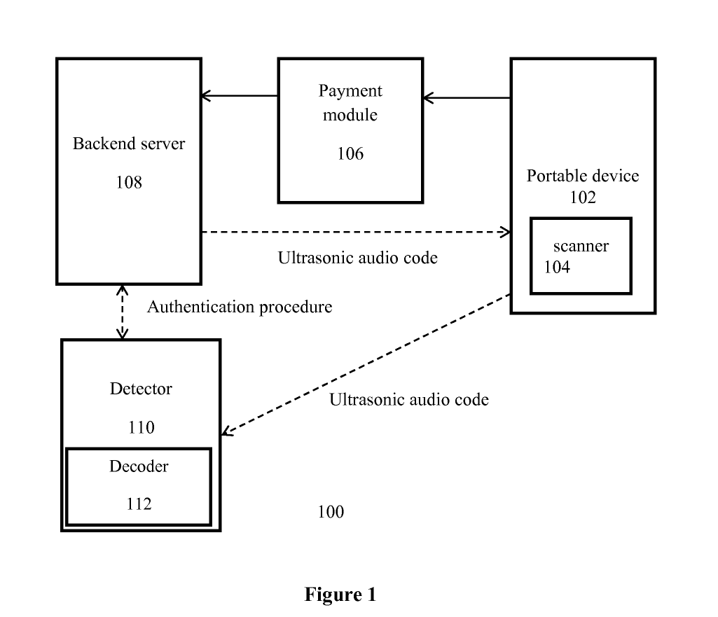

Referring to FIG. 1, the system 100 broadly comprises of a scanner 104 embedded within a portable device 102, a payment module 106, a backend server 108 and a detector 110. The portable device 102 allows a consumer to walk-in a retail store and select items for purchase. The scanner 104 is used to scan the details imprinted on the item. The consumer scans all the necessary items that he/she needs to purchase and in assistance with the payment module 106 processes the entire payment transaction.

The payment module 106 is connected to the back end server 108 of the system 100 and post execution of a successful transaction a confirmation is delivered to the backend server. Upon receipt of the confirmation of payment, a flag is set on the server side to initialize the transmission of the ultrasonic audio code targeted to be received by the portable device. The targeted portable device is identified by using certain predefined parameters including but not limited to IMEI number, MAC address, IP address and the like.

The backend server 108 now transmits ultrasonic audio code to the portable device 102 that has successfully completed the transaction. Further the detector 110 is adapted to detect and decode the ultrasonic audio code and verify the same with the backend server for a valid transaction.

The detector 110 is responsible for detecting and capturing the ultrasonic audio code transmitted by the portable device and executing the verification process to identify the consumer performing the successful transaction and allow him to exit the premises. The verification process involves extracting the data from the ultrasonic audio code and comparing against the transaction details that are maintained for each transmitted audio code vis a vis each transaction, on the backend server.

FIG. 1 represents the overall components involved to implement hassle free unmanned purchasing within a retail environment. Any consumer who enters a retail store is believed to carry a portable device 102 having a scanner embedded in it. The consumer scans the information imprinted on the items present in the retail store. The scanned items help the consumer fill the cart for purchase. Once the consumer has finished his/her purchasing the payment module 106 assists in processing the transaction and confirmation of the payments to the retail store. The payment module generates confirmation post successful payment from the consumer and transmits the confirmation signal to the backend server to initialize transmission of ultrasonic audio code to the portable device. The portable device hereafter transmits the received code which is then detected by the detector 110. The detector 110 further comprises of a decoder 112 that extracts and decodes the data from the audio code and transmits it back to the backend server. The server 108 now compares the decoded data with a set of transaction parameters maintained for each transaction at the backend server. In an embodiment, the said detector can optionally be placed near the exit of the store or at any other strategic position.

In an alternate embodiment, the backend server may transmit a first ultrasonic audio code to the portable device that has confirmed of a successful transmission and a second ultrasonic audio code to the detector 110 for verification. The detector thus, on a whole, receives two set of ultrasonic audio codes, 1^{st} ultrasonic audio code being received from the portable device and 2^{nd} ultrasonic code from the backend server 108. The major task of the detector is to detect, compare and verify the 1st and 2nd ultrasonic audio codes so received. Based on verification, a predefined event will occur. In an embodiment, the event can be opening of a security gate at the exit of the retail store or any other similar event.

In a primary embodiment, the detector 110, may not receive the 2^{nd} ultrasonic code from the backend server. Instead, the detector may extract the data encoded in the ultrasonic audio code and contact the backend server for verification of the transaction parameters. Based on verification, a predefined event will occur. In an embodiment, the event can be opening of a security gate at the exit of the retail store or any other similar event.

It is quite evident from the process described above that the consumer is facilitated with a hassle free, unmanned, undeterred purchasing experience in a retail environment.

According to one exemplary embodiment, the customer carrying a portable device walks in to a store. The application in the portable device identifies the exact store based on the beacon being transmitted by in-store audio devices. As and when the consumer picks an item from the store shelf, and scans the item using an application of the portable device, the application uses store information (including the location of the store) to apply requisite price and promotions. The application advantageously uses the store information to apply the correct price, promotions and taxes to the product purchase. The consumer can add these item(s) to his cart and is now ready to checkout after making the desired payment using either an online store account—like iTunes—or using some other kind of mobile payment like NFC, or online banking, or store account, store credit/debit card etc upon communication with the payment module 106. The portable device shall then receive a payment confirmation from the backend server in the form of ultrasonic audio encoded code for further transmission to the detector 110. The ultrasonic code is now decoded by the decoder component of the detector that is configured to detect the transmitted code from the portable device. The decoded code is then verified by the detector by way of comparison with the transaction details maintained at the backend server.. The invention allows automatic playing of the audio code without any user intervention, enabling the consumer to exit the store undeterred, thereby providing a complete hassle free checkout experience.

In one typical embodiment of the present invention, the system automatically, after a checkout process plays the ultrasonic audio code continuously at a low volume so as to allow only selective listening devices detected in close proximity to pick up the audio. This allows a consumer to exit the store undeterred. In another embodiment of the invention the ultrasonic audio code is played at random intervals ranging from a few seconds up to 10 s so as to minimize chances of interference from other portable devices. The audio is picked up by any store device (or a detector as shown in FIG. 1) including a handheld mPOS terminal. In another alternate embodiment, the store personnel at the mPOS terminal may visually verify the purchase and stop a consumer at random or in case of some suspicion.

In the other alternative embodiment of the present invention, instead of an ultrasonic audio code, the backend server 108 and the portable application uses one of many other techniques like QR code or barcode or an electronic receipt that could be visually communicated by the portable device to a store device (or a detector as shown in FIG. 1) on the way out. This requires the consumer to consciously perform an action to bring the portable in close proximity with a reader to read the QR code or barcode.

In one of the other alternative embodiments, instead of the detector listening to the audio code, the store uses an mPOS (mobile Point Of Sale) terminal for such activity. The code so communicated to the device by the backend server is potentially used to communicate information like total number of items bought, and the total payment made by the consumer, the date and time of purchase. Such information can be used by the listening device to protect against replay by the consumer or anyone else. It shall be however be acknowledged that in all the embodiments of the present invention there is no single store employee involved at any time.

In the other alternate embodiment, the code contains an Id that can identify the checkout transaction which would then provide other information like date and time of purchase, the list of items bought by the consumer, mode of payment, etc. Such information will be useful for a person with an mPoS terminal to verify the purchase when the consumer exits the store. It is expected that the transmission of code to the device and from the device to the store device (or a detector as shown in FIG. 1) will be done using secure channels.

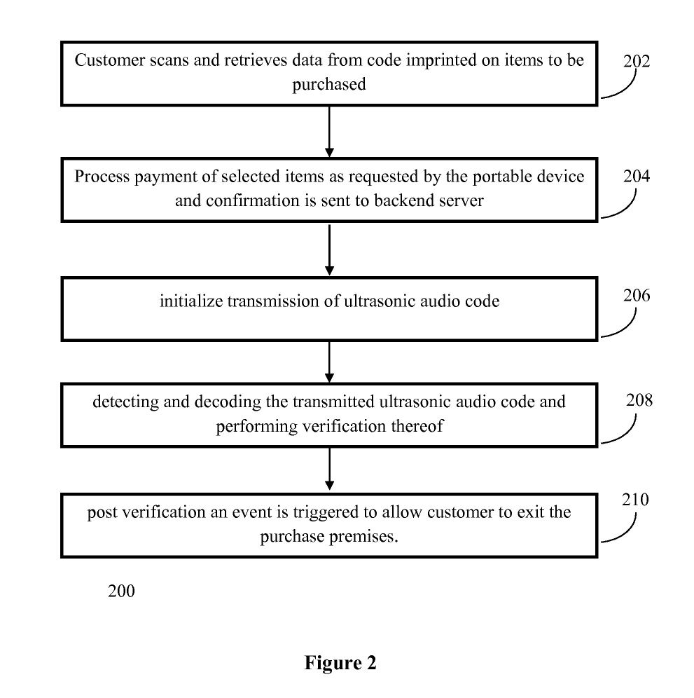

Next, referring to FIG. 2 a stepwise process for enabling a customer experience an undeterred purchasing experience within a retail environment using ultrasonic audio code is shown. In the FIG. 2, step 202 involves retrieving of the data imprinted on the items in the store after scanning the items using the portable device. The scanned devices are added to a cart for payment processing. Step 204 involves processing of payment based on the selection of items in the previous step. Post the payment using the payment module a confirmation is sent to the backend server by the payment module. The confirmation is used to set a flag on the server side and once the flag is set, transmission of ultrasonic audio code is initiated as shown in step 206. To terminate the said transmission the flag needs to be reset. In step 208 the detector detects the transmitted ultrasonic audio signals and verification process is initiated that involves decoding of the received audio code via a decoder embedded within the detector and thereon comparing the decoded ultrasonic audio code with a set of transaction details maintained for each transaction in the database of the backend server. Successful verification results in triggering of an event like opening of a security gate post, triggering an alarm and the like as illustrated in step 210.

In an alternate embodiment, once the flag is set, transmission of two set of ultrasonic audio code is initiated by the backend server, wherein the first ultrasonic code is targeted to be received by the portable device and the second ultrasonic code is being received by the detector. The detector now detects the first ultrasonic code, as transmitted by the portable device and compares it with the second ultrasonic code received from the backend server. Upon a successful comparison backend server informs the detector about successful verification. Successful verification results in triggering of an event like opening of a security gate post, triggering an alarm and the like as illustrated in step 210.

In another embodiment the portable device is capable of transforming the first ultrasonic audio code and generating a second ultrasonic audio code. Instead of the backend server communicating the audio code, the portable device generates the ultrasonic audio code on its own using combination of typical transaction parameters received from the backend server and portable device specific parameters including but not limited to IMEI, MAC address, and the like. The processor coupled to memory of the portable are utilized to obtain the information and accordingly generate the first ultrasonic audio code. Usage of portable device specific parameters will further protect from listen and replay of code by other portable devices in the vicinity.

In another embodiment of this invention each of the portable devices is capable of making multiple payments. For each payment corresponding ultrasonic audio code is generated. The generated audio code may reference a consolidated purchase transaction at the backend. The consolidated transaction could be a summation of all transactions after the last exit from the store. The portable device shall then play the last received audio code only. The verification procedure involves verification of the ultrasonic audio codes received from the particular portable device thereof, and is no different than the case when the user would have made a single purchase transaction. This reduces the chances of interference that can be caused due to the multiple generated ultrasonic audio codes from a single portable device. Alternately the portable device could receive an audio code for each transaction and it will play each of these audio codes during store exit process. In such case the portable device and the detector will collaboratively work to handle any interference using mechanisms described elsewhere in this document.

In another embodiment of this invention the portable device may receive multiple different ultrasonic audio codes from the backend server, each in a different frequency band. In cases where interference is observed during exit procedures the portable device will randomly select another ultrasonic audio code from the ones sent by the backend server and will replay the audio code. The portable device will continue to use the above mentioned procedure until it is able to successfully play and hear the audio tone with no interference. Frequency hopping, amplitude control and the like techniques are utilized to work around the audio interference issue.

It is well received from the various embodiments of the invention, that since the consumer is not required to bring his purchases to a specific location and a specific terminal in the store and then wait for his turn to use the self-checkout terminal, it cuts down on a lot of wasted time for the consumer. The consumer also benefits by knowing the exact price of a product much earlier when he scans the product using his portable device as against having to wait to get to checkout terminal to scan the product.

The other advantageous feature of the present invention obviates the need of stores to invest in theft detection systems as the communication of a payment confirmation code encoded in ultrasonic audio acts a proof of payment. Further, the store device (or a detector as shown in FIG. 1) could advantageously control exit doors, which opens only when the purchase is verified.

By doing the above, the need for a designated location, terminal and personnel for a store checkout is eliminated, thus realizing cost savings for the store. Also, the buying experience of a consumer is significantly improved since he does not have to wait in a queue to scan the goods in his cart and pay for his purchase, neither does he have to wait for someone to verify his/her purchase before exiting the store.

This invention can be used at all retail stores for self checkout by a consumer. Through this invention a consumer can realize a complete checkout experience without having to involve any store personnel. This invention asserts the possibility of having unmanned stores where a consumer can walk in, checkout goods from the store, pay for the goods and also present a proof of payment at the store exit. The invention benefits the store and the consumers alike. The store benefits by not having to invest in separate space, terminal and employees for checkout process. The consumers benefit by not having to wait in a queue to checkout their goods and pay for the same.

The preceding description has been presented with reference to various embodiments of the invention. Persons skilled in the art and technology to which this invention pertains will appreciate that alterations and changes in the described structures and methods of operation can be practiced without meaningfully departing from the principle, scope of this invention.

We claim:

1. An unmanned transaction system characterized in verifying customer identity via ultrasonic coded authentication procedure by using a portable device, the system comprising:
a scanner embedded within the portable device to scan identification data imprinted on one or more items to be purchased;
a payment module facilitating the performed purchase of the scanned items;
a backend server, configured to transmit an ultrasonic audio code to the portable device identified of performing the transaction upon confirmation from the payment module; and
a detector adapted to receive the ultrasonic audio code from the portable device and verify said ultrasonic audio code with a corresponding copy thereof maintained at the backend server.

2. The system of claim 1, wherein the portable device refers to but is not limited to a mobile device, cellular phone, portable digital assistant (PDA) and the like.

3. The system of claim 1, wherein the identification data may include but is not limited to item number, item cost, discounts, promotions and the like.

4. The system of claim 1, wherein the payment module processes payments requested to be processed by the portable device via plurality of payment means including but not limited to credit card, virtual store, paypal and the like.

5. The system of claim 1, wherein the ultrasonic audio code refers to an audio file of varying file formats including but not limited to .mp3, .amr, .aac, .wmv and the like.

6. The system of claim 1, wherein the detector further comprises of a decoder to extract data from the detected ultrasonic audio code for transmission to the backend server.

7. A method for enabling an unmanned transaction characterized in verifying customer identity via ultrasonic coded authentication procedure by using a portable device, the method comprising:
retrieving identification data imprinted on one or more items to be purchased via a scanner embedded within the portable device;
processing a payment transaction, by the portable device in communication with a payment module, for the each scanned items;
for the each processed transaction of the scanned items, initializing transmission of an ultrasonic audio code to the portable device identified of performing the transaction for a specified time interval; and
detecting the ultrasonic audio code transmitted by the portable device on the detector and verifying the detected code with a corresponding copy thereof maintained at the backend server.

8. The method of claim 7, wherein the portable device refers to but is not limited to a mobile device, cellular phone, portable digital assistant (PDA) and the like.

9. The method of claim 7, wherein the identification data may include but is not limited to item number, item cost, discounts, promotions and the like.

10. The method of claim 7, wherein the payment transaction refers to processing of the payments requested to be processed by the portable device via plurality of payment means including but not limited to credit card, virtual store, paypal and the like.

11. The method of claim 7, wherein the verification process involves extracting a data from the detected ultrasonic code and comparing the extracted data with a set of transaction details of corresponding copy thereof, maintained at the backend server.

12. The method of claim 7, wherein the ultrasonic audio code refers to an audio file of varying file formats including but not limited to .mp3, .amr, .aac, .wmv and the like.
